(19) United States
(12) Patent Application Publication
(10) Pub. No.: US 2012/0307023 A1
(43) Pub. Date: Dec. 6, 2012

(54) DISPARITY DISTRIBUTION ESTIMATION FOR 3D TV

(75) Inventors: Volker Freiburg, Backnang (DE); Thimo Emmerich, Stuttgart (DE)

(73) Assignee: Sony Corporation, Tokyo (JP)

(21) Appl. No.: 13/578,281

(22) PCT Filed: Mar. 3, 2011
(86) PCT No.: PCT/EP2011/053204

§ 371 Date: Aug. 10, 2012

(30) Foreign Application Priority Data
Mar. 5, 2010 (EP) 10 155 576.1

(51) Int. Cl. H04N 13/04

(52) U.S. Cl. 348/51; 348/E13.075

(57) ABSTRACT

A method and apparatus for estimating a disparity distribution between a left image and a right image of a stereoscopic 3D picture, each image having an array of pixels, including: providing a maximum range of disparity; correlating, by an estimation device, a left image area with a right image area, with one of both image areas being shifted by a disparity shift value, wherein the result of the correlation is an indication of a pixel match between both images; repeating the correlating for a set of disparity shift values within the maximum range of disparity; and deriving the disparity distribution from the results of the correlation.

### FIELD OF INVENTION

The present invention relates to a method for estimating a disparity distribution between a left image and a right image of a stereoscopic 3D picture, each image having an array of pixels. The invention also relates to an apparatus for estimating a disparity distribution as well as a television apparatus for displaying stereoscopic 3D pictures. Moreover, the invention relates to an apparatus for recording, processing and/or displaying 3D pictures, and a computer program product.

### BACKGROUND OF THE INVENTION

The principles of stereoscopic 3D cinematography are known for a long time, but recently it became very popular and the demand for devices being able to display stereoscopic 3D content is increasing rapidly. In particular, the entertainment industry has begun to develop television devices with a stereoscopic 3D capability. However, a principle problem with the display of stereo-scopic 3D content is the often occurring discrepancy between shooting condition and viewing condition related to the depth impression perceived by the viewer. Factors for the depth impression are the display screen size of the television set, the distance and position of the viewer in front of the display, and the individual interocular (eye) distance. While the eye distance is considered to be less variant among adults, a problem exists specifically for children. In most cases, the viewing condition is not known when the content is produced. On the other hand, metadata describing the shooting condition could be attached to the content, but this is not standardized. This problem is of particular interest, because of the variety of different display screen sizes of television sets, distances and positions of the viewer compared to the conditions in a movie theatre.

The display of 3D content can therefore present problems for the viewer. Common problems can be the experience of eye divergence when looking at a far point of the scene, or the confusing impression between eye vergence and eye accommodation when fixating an object with too high apparent distance from the display screen.

In the prior art, the use of a so-called “comfort zone” has been established. The “comfort zone” defines an area before and behind the screen or display plane of a TV set in which the fixating of an object could be done by the viewer without any eye vergence and eye accommodation problems. In other words, the comfort zone describes the depth relative to the display screen which should be used for displaying objects.

This comfort zone, which defines a depth range around the screen or display plane, is closely related to the disparity between left and right view. A method to change the perceived depth for the viewer is therefore to change the disparity between left and right image. In the simplest form, this can be achieved by a horizontal scale and shift operation of left and right image when presented on the display. The scale operation applied equally to both images will scale the disparity range by the same amount. The horizontal shift of left vs. right image will reposition the plane of zero disparity, i.e. a specific depth plane in the scene can be positioned in the plane of the display screen in order to adjust the scene depth within the comfort zone of the display.

In other words, one of the main problems of displaying 3D content is to bring the depth range used in the delivered stereoscopic 3D content into the comfort zone of the display device, for example a television set. This is achieved by scaling the depth range such that the maximum depth range of the delivered content substantially corresponds to the depth range of the comfort zone. Further, the depth range of the delivered content may also be shifted relative to the display screen plane.

More detailed information about 3D cinematography fundamentals, like the 3D comfort zone, may be found in “3D Movie Making, Stereoscopic Digital Cinema from Script to Screen” Bernard Mendiburu, Focal Press, ISBN 978-0-240-81137-6, particularly Chapter 5, the content of which is incorporated by reference herewith.

In order to derive the proper parameters for scale and shift operations, the range of disparity must be known beforehand. In this context, the range of disparity is defined as representing at least the minimum and maximum disparity present in the content. Preferably, the distribution of disparity levels between these extremes is also known. This information is usually not available from metadata attached to the content and must be recovered from the image content itself.

A naïve approach to generate a disparity distribution is the estimation of a dense disparity map in which a disparity value is assigned to each pixel position in the input images. Then, a histogram is computed from the dense disparity map. The disadvantage of this method is the inefficiency of first searching for localized depth information, and then discarding it.

### SUMMARY OF INVENTION

It is an object of the present invention to provide an efficient method that is able to estimate the global distribution of disparity between a left and a right view image. It is a further object of the present invention to provide an apparatus which is able to estimate the global distribution of disparity in an efficient manner.

According to an aspect of the present invention there is provided a method for estimating a disparity distribution between a left image and a right image of a stereoscopic 3D picture, each image having an array of pixels, comprising the steps of

Providing a maximum range of disparity;

Correlating a left image area with a right image area, with one of both image areas being shifted by a disparity shift value, wherein the result of the correlation is an indication of the pixel match between both images;

Repeating the correlating step for a set of disparity shift values within the maximum range of disparity;

Deriving the disparity distribution from the results of the correlation.

That is in other words that one of the left or right image areas is compared with the other image area shifted by a disparity shift value in order to determine how many pixels between both images match. If for example all pixels of the one image area completely match with the shifted other image area, the whole content lies in the same depth plane with a disparity (which is an indication of the position of the depth plane relative to the display plane) corresponding to the used disparity shift value.

This correlating step is repeated for a couple of disparity shift values within the given maximum range of disparity. At the end, there is a correlating result for every used disparity shift value, the results being then combined to the disparity distribution.

This disparity distribution can be employed for further image processing used to bring the stereoscopic 3D content into the comfort zone.

The core principle of the proposed inventive method is hence based on a non-linear correlation of left and right image. One of the two images is horizontally shifted against the other by d pixel columns (i.e. a disparity shift value), and a correlation operation is performed for the same area in the first image and the shifted version of the other image. This method for providing the proper parameters for scale and shift operations, namely a disparity distribution, is very efficient because of the simple pixel operations necessary.

According to a preferred embodiment, the set of disparity shift values comprises all integer values within the maximum range of disparity, wherein the unit of the disparity shift value as well as the maximum range of disparity is a pixel.

That is in other words that the correlating step is carried out for every disparity shift value within the given maximum range of disparity. This maximum range of disparity is defined by a minimum disparity value and a maximum disparity value. Both disparity values may be equal, however with different signs so that the described range is symmetrical to zero. However, both values may also be selected asymmetrically in case that any respective information is available. Generally, the maximum range of disparity defines the expected maximum depth range of the delivered stereo-scopic 3D content, or in other words the maximum expected disparity contained in the content. The disparity values mentioned may also be defined on the basis of constrains of computational resources or any compromise between the expected disparity and computational resources constrains.

In a preferred embodiment, the image area used for correlating is the overlapping area of the one image area and the shifted other image area. More preferably, the left and the right image areas for correlating are trimmed at the left and right borders by a value preferably corresponding to the maximum range of disparity.

This measure avoids that the correlation area crosses the boundaries of either image.

In a further preferred embodiment, the correlating step comprises the steps of comparing both image areas with each other pixelwise, and

increasing a counter in response to the result of the comparison, wherein the counter indicates the match of the pixel values for both image areas, one of which being shifted by the disparity shift value. More preferably, the step of comparing both image areas pixelwise comprises the step of subtracting the value of each pixel of one of both image areas from the value of each respective pixel of the other image area. More preferably, the counter is increased if the absolute value of the result of the comparison is below a predetermined threshold, preferably one.

In other words, the correlating step comprises a simple subtraction operation between two pixel values and if the absolute value of the result of this subtraction is below a predetermined threshold a counter is increased by one. Hence, every time a pixel matches the respective pixel in the shifted image the counter is increased. Hence, the higher the counter is the higher is the number of matching pixels.

However, there is to be noted that the result of the correlation does not comprise any spatial information about the matching pixels. In other words, the correlating step does not supply any information about a certain disparity value and the respective region within the image area. This makes this method so efficient.

According to a further preferred embodiment, the image areas are shifted horizontally relative to each other.

In a further preferred embodiment, the left and right image areas are divided into a number of subareas, and the correlating step is carried out for each subarea separately, so that a disparity distribution is derived for every image subarea. Preferably, the disparity distributions of the subareas are combined to a single distribution. More preferably, the number of subareas is nine.

The inventors have noted that the disparity distribution derived by the above-mentioned method has the property that it is very smooth and that peaks correspond to large objects in the stereoscopic input. In order to avoid masking of peaks corresponding to smaller objects at different depth planes, the inventors have found out that using multiple correlation areas is advantageous.

In a further preferred embodiment, each subarea is analyzed whether it contains any structured elements. Preferably, a weight factor for each subarea is determined depending on the analyzing result, wherein the weight factor is used for the combination of the disparity distributions.

Because disparity can only be estimated when the image content exposes some minimum structure, each subarea is tested whether it contains structure or only flat or uniform color values. A computational efficient test can be performed on the distribution obtained from the correlation, observing that sufficient structure in the content results in sharply located, pronounced peaks. In case of only weak or no structure, peaks become weak as well, possibly extending over the whole search range. Preferably, the peak curvature is evaluated using its second derivative to determine a weight factor that is used in the subsequent combination step.

In a further preferred embodiment, a non-linear transfer function is applied to each subarea disparity distribution before combining the subarea disparity distributions to enhance large peaks and attenuate small peaks and noise.

In a further preferred embodiment, a set of subarea disparity distributions is combined. Preferably, the set of subarea disparity distributions only comprises those relating to subareas located at the image border, preferably the top and bottom image borders.

Hence, another aspect of the proposed method is that the combination of subarea distributions can comprise different subsets instead of the full image area. For example, the distribution of all subareas located at the top and bottom image borders can be combined to obtain a disparity distribution of the border area. Such a distribution could be used to search for border violation of scene content, i.e. when an object that is located at a depth plane nearer to the viewer is cut by the image border located in the display plane.

In a further preferred embodiment, the proposed method is also suitable for stereo-scopic material that contains rectified left and right views, i.e. that epipolar lines of the inherent view geometry are aligned with the image rows. Furthermore, left and right view should have equal exposure or brightness. While these requirements ensure best portrayal on a stereoscopic display, they are still violated by most of today's content.

The proposed method can therefore be extended to include also preprocessing means to first compensate global illumination differences between left and right view. Secondly, a vertical shift between left and right correlation area is determined for each correlation area. Finally, the horizontal distribution may be estimated as described above.

According to a further aspect of the present invention there is provided an apparatus for estimating a disparity distribution between a left image and a right image of a stereoscopic 3D picture, each image having an area of pixels, comprising:

an estimation device adapted to correlate a left image area with a right image area, with one of both image areas being shifted by a disparity shift value, wherein the result of the correlation is an indication of the pixel match between both images, repeat the correlation for a set of disparity shift values within a given maximum range of disparity; derive the disparity distribution from the results of the correlation; and output the derived disparity distribution.

The inventive apparatus have the same advantages as mentioned above with respect to the inventive method. Therefore, it may be referred to the respective description above. Further, the apparatus have similar and/or identical preferred embodiments as described with respect to the method. Hence it may be refrained from repeating these embodiments and the corresponding advantages.

Finally, according to a further aspect of the present invention there is provided an apparatus for playing stereoscopic 3D pictures, preferably a television set, which comprises the inventive apparatus mentioned above.

To sum up, the present invention proposes a method which is computationally more efficient than the mentioned naïve approach. Further, the inventive method is less complex than the naïve approach. Therefore, it can be implemented more easily in hardware (e.g. ASIC) or in software for processors with vectorized computational units (e.g. VLIW, CELL). Further the inventive method is more robust than the naïve approach or content that exposes periodic structures.

Apart from changing the depth impression of an image pair carried out on the basis of the disparity distribution provided by the inventive method, other potential applications for the inventive method conceivable, in particular for the full range of devices from the lens to the living room, and may include:

a) On-the-fly metadata generation, e.g. to find the depth distance nearest to the viewer in order to place subtitles or an on-screen menu properly in front of the scene;

b) a still picture or video camera device,

c) a content post-production system for home video or as used by a a broadcaster,

d) a media playing device based on a computer product or gaming console using packaged media like Blu-Ray or streaming media from internet,

e) a display device not restricted to a TV apparatus but also including pure stereocopic monitor devices and projection systems.

While the application for case e) focuses on the control of perceived depth based on the display/viewers condition as described below, a potential application for case b) and c) could be an interactive feedback to the photographer or production operator indicating an ill-conditioned shooting situation, where a too high disparity range is known to cause problems in the down-stream processing chain. For case c), d), and e) an application is the depth positioning of captions or subtitles as well as the positioning of the on-screen menu with which such devices are controlled. For cases c) or d) the information could be used to improve the codec efficiency regarding interview prediction, in terms of computational effort and/or picture quality of the stream.

It is to be understood that the features mentioned above and those yet to be explained below can be used not only in the respective combinations indicated, but also in other combinations or in isolation, without leaving the scope of the present invention.

### BRIEF DESCRIPTION OF DRAWINGS

These and other aspects of the present invention will be apparent from and explained in more detail below with reference to the embodiments described hereinafter. In the following drawings

FIG. 1 shows a typical viewing geometry with a display plane and an observer;

FIG. 2 shows the viewing geometry with a display comfort zone;

FIGS. 3A and B show examples of a disparity distribution;

FIG. 4 shows a block diagram with an image analyzes and an image transformation part;

FIG. 5 shows a block diagram for describing the core principle of the invention;

FIG. 6A shows a flow process diagram for explaining a correlating step of the invention;

FIG. 6B shows an example of an image area used during the correlating step;

FIG. 7 shows an image area divided into a plurality of subareas used in a further embodiment of the invention;

FIGS. 8A and 8B show block diagrams of a post-processing of the disparity distributions;

FIG. 9 shows an example of an input-to-output relation of a non-linear mapping employed in FIG. 8A; and

FIGS. 10A and 10B show examples how to estimate the disparity distributions at image borders.

### DESCRIPTION OF PREFERRED EMBODIMENTS

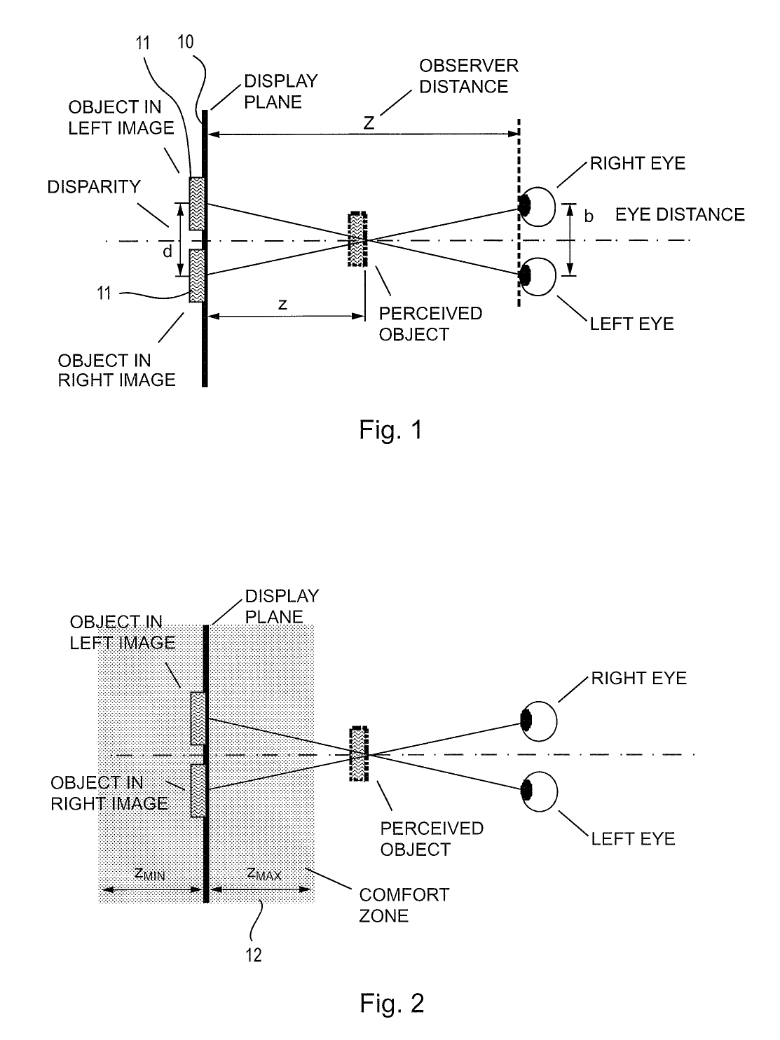

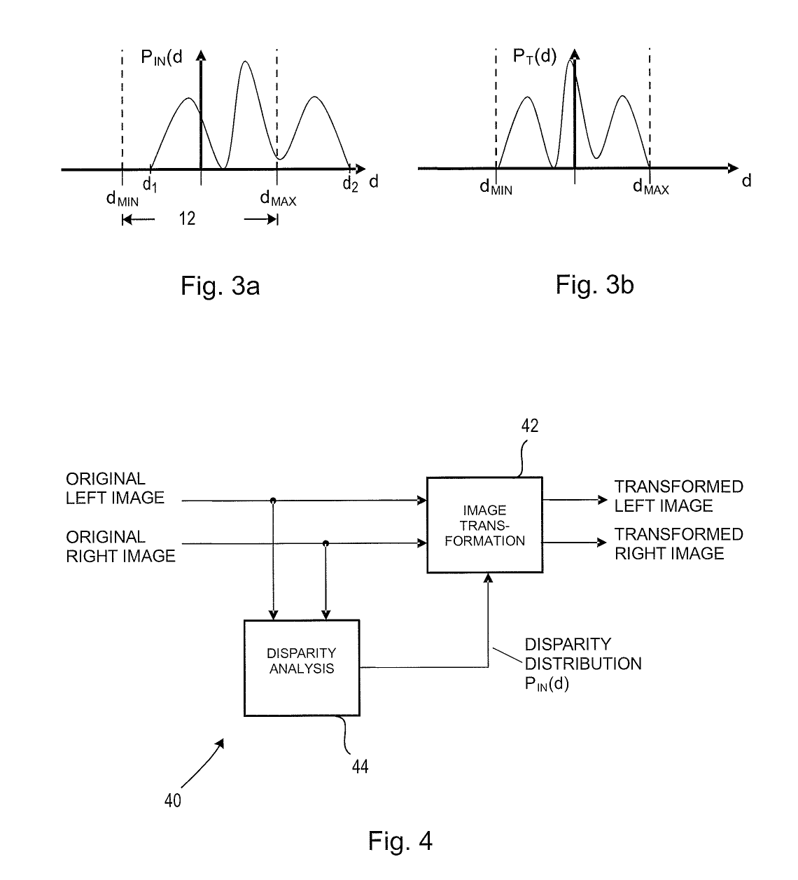

Before going into a detailed description of preferred embodiments, it is first given some general background information about stereoscopic 3D principles with respect to FIGS. 1 and 2 and the technical field the present invention is applied (FIGS. 3A, B and FIG. 4).

In particular, these general remarks also serve to define terms which are used below in order to avoid any ambiguities which could raise because certain terms are used with different meanings in the literature.

FIG. 1 schematically shows a typical viewing geometry. On the left side of FIG. 1, a display plane is shown and indicated with reference numeral 10. The display plane is part of a TV set employed for displaying 3D movies.

On the right side of FIG. 1, the observer's eyes are schematically shown, wherein the eye distance of the left eye and the right eye is indicated with b. The distance between the observer and the display plane 10 is indicated with Z and is typically within a range of 1 meter to 5 meters.

As it is generally known, each 3D image comprises a right image and a left image which are displayed alternately. The observer typically wears for example shutter glasses synchronized with the display plane so that the observer sees the left image with the left eye only and the right image with the right eye only.

For illustrating purposes, FIG. 1 shows a rectangular symbolizing an object in the image. To achieve a 3D perception, the object 11 in the right image may be shifted by a distance d relative to the object in the left image. In other words, the object 11 may be presented to the observer in different locations on the display plane for the right eye and the left eye. The distance between the object in the right image and the object in the left image in a horizontal direction is called hereinafter “disparity” d. Dependent on this disparity, the observer has the impression that the object is before the display plane or behind the display plane.

For a disparity of zero, meaning that the object in the right image is displayed in the same position on the display as the object in the left image, the observer perceives the object in the display plane 10.

In the example shown in FIG. 1, the object in the left image is displayed in the right half of the display whereas the object in the right image is displayed in the left half of the display. In this case, the disparity is assumed to be positive and the perceived object lies in front of the display plane, with a distance being indicated with z (depth range). If the disparity d becomes smaller, the perceived object travels towards the display plane. As soon as the disparity d becomes negative, the perceived object lies behind the display plane.

Due to the fact that the display of a TV set is pixel-based, the unity of the disparity is a pixel hereinafter. That is in other words that a disparity of one means that the left image is shifted in horizontal direction by one pixel relative to the right image.

It is apparent from FIG. 1, that the distance z between the display plane and the object perceived by the observer is a monotonic function of the disparity d.

Although in theory the distance z of the perceived object relative to the display plane may take any value between zero and the observer's distance Z for a positive disparity and from zero to infinity for a negative disparity, it has turned out that certain disparities cause disturbing effects to the observer. In particular, the observer may get a headache if the disparity d becomes too large.

Due to this knowledge a so-called “comfort zone” has been established. The comfort zone defines a depth range before and behind the display plane which does not cause any disturbing effects to the observer if a perceived object lies within this zone. This comfort zone is indicated in FIG. 2 with the reference numeral 12. The comfort zone extends by a distance or depth relative to the display plane of zₘₐₓ before the display plane and zₘᵢₙ behind the display plane. A more detailed explanation of the comfort zone may be found in the above-mentioned literature “3D Movie Making”, Chapter 5, which is incorporated by reference herewith.

In the following, it is assumed that zₘᵢₙ is a negative value and zₘₐₓ a positive value. Further, it is assumed that the absolute values of zₘᵢₙ and zₘₐₓ are equal, meaning that the comfort zone is symmetrical to the display plane. However, it is to be noted that the absolute values of zₘᵢₙ and zₘₐₓ may also be unequal. The comfort zone depends on the viewing geometry, which includes certain parameters of the used TV set, like the display size, and the viewer's position and individual interpupillary distance.

Due to this dependency between comfort zone and TV set parameters, it is nearly impossible for a movie broadcaster, for example, to supply information by means of metadata defining the comfort zone. Hence, there is a demand and necessity to process the supplied images and to adapt the disparity to the comfort zone. That is in other words that the TV set has the task to shift all objects lying outside the comfort zone into the comfort zone. Since the depth z is a monotonic function of the disparity d such an image processing may be based on the disparity as an input argument. In particular, a disparity distribution between a left and a right image is used as an input argument. A disparity distribution, for example, provides the minimum and maximum disparities in an image and hence the maximum depth range of the image which has to be scaled into the comfort zone.

In FIGS. 3A and B two examples of disparity distributions are shown. In FIG. 3A, the disparity distribution P_{in(d)} extends beyond the boundaries of the comfort zone which are indicated by dₘᵢₙ and dₘₐₓ. It is apparent that the disparity range d1 to d2 is greater than the disparity range of the comfort zone. Further, the main area or center of the distribution is offset to the center of the comfort zone which is in the present case the display plane.

Hence, in order to avoid any disturbing effects to the observer, the image has to be processed to bring the disparity distribution into the comfort zone. This processing requires a shifting step to bring the center of the distribution onto the center of the comfort zone and a scaling step to scale the disparity range d1 to d2 to the disparity range of the comfort zone Dmin to Dmax. The result of such an image processing is then shown in FIG. 3B. This image processing or transformation provides an image with all objects perceived by the observer lying in the comfort zone.

In FIG. 4, a block diagram of a part of an image processor employed in a television apparatus is shown and indicated with reference numeral 40. One task of the image processor 40 is to carry out an image transformation as mentioned before. The image processor therefore comprises an image transformation means 42. The image transformation means 42 receives as an input the original right image and the original left image. The output of the image transformation means 42 is then a transformed left image and a transformed right image.

As an argument for the image transformation, the image transformation means 42 receives a disparity distribution P_{in(d)} as an input. For calculating this disparity distribution, the image processor 40 comprises a disparity analysis means 44 which also receives as an input the original left image and the original right image.

The subject of the present application is the provision of the disparity distribution P_{in(d)} processed by the disparity analysis means 44. The image transformation is part of Japanese patent application 2009-199139 of the assignee (Sony reference number 09900660), the content of which is incorporated by reference herewith, and will therefore not be described any more hereinafter.

In the following, the disparity analysis means 44 and in particular its functionality will be described.

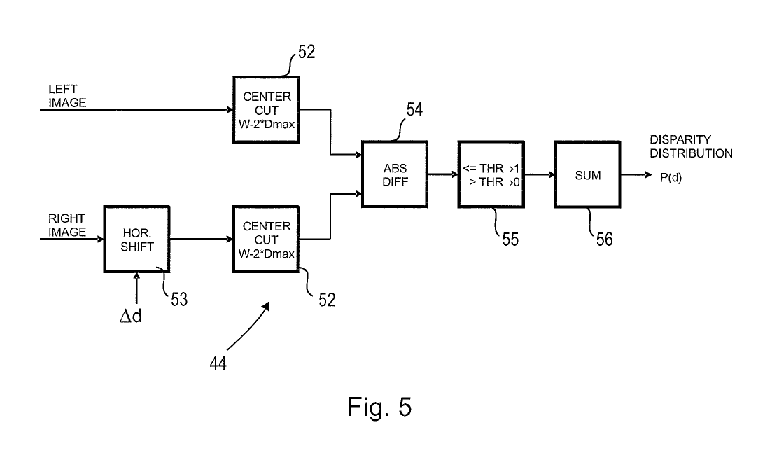

FIG. 5 is a block diagram of a portion of the disparity analysis means 44.

It comprises center cut elements 52, one for processing the left image and one for processing the right image. The center cut element 52 serves to cut or trim the supplied image to reduce the image width. In other words, the center cut element 52 cuts off a left and a right margin of the image, the width of this margin being indicated by Dmax. The output of the center cut element 52 is an image with a image width reduced by 2×Dmax relative to the original width W.

The disparity analysis means 44 further comprises a horizontally shifting element 53 which is assigned in FIG. 5 to the signal path of the right image. The shifting element 53 receives as an input argument a shifting value Δd and carries out a shifting of the supplied image by Δd pixels in the horizontal direction. Depending on the sign of Δd, the image is shifted to the left or the right.

The disparity analysis means also comprises a correlating element 54 which receives as input the center cut left image and the center cut and horizontally shifted right image. The correlating element 54 is adapted to compare the left and right images pixelwise. The result of the pixelwise comparison is then compared with a threshold. If the absolute value of the comparison result is smaller or equal to the threshold, a counter signal is generated. Otherwise, that is if the absolute value of the comparison result is greater than the threshold, no countersignal is generated. The counter signal is supplied to a counter element 56 which increases a counter by one if it receives a counter signal. The output of the counter element 56 is a disparity distribution value for the particular disparity Δd.

The disparity analysis means shown in FIG. 5 is adapted to implement the core principle of the present invention. It allows to estimate the disparity distribution between a left and right image pair for a couple of different Δd values. In other words, this disparity analysis means allows to determine the pixel matches of an image pair for a predetermined range of Δd values so as to gain the desired disparity distribution.

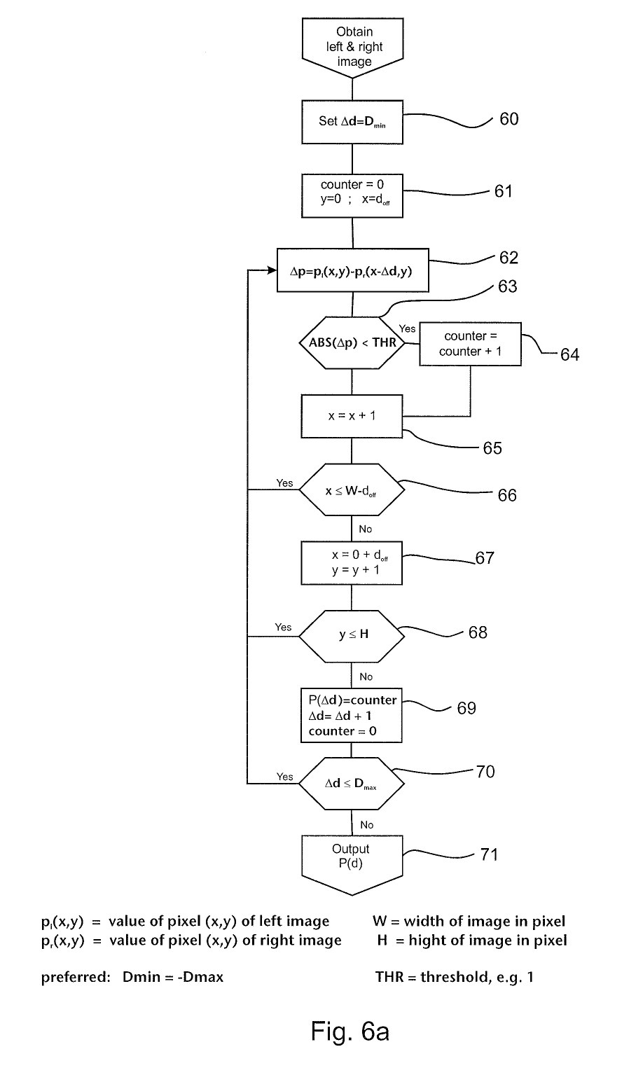

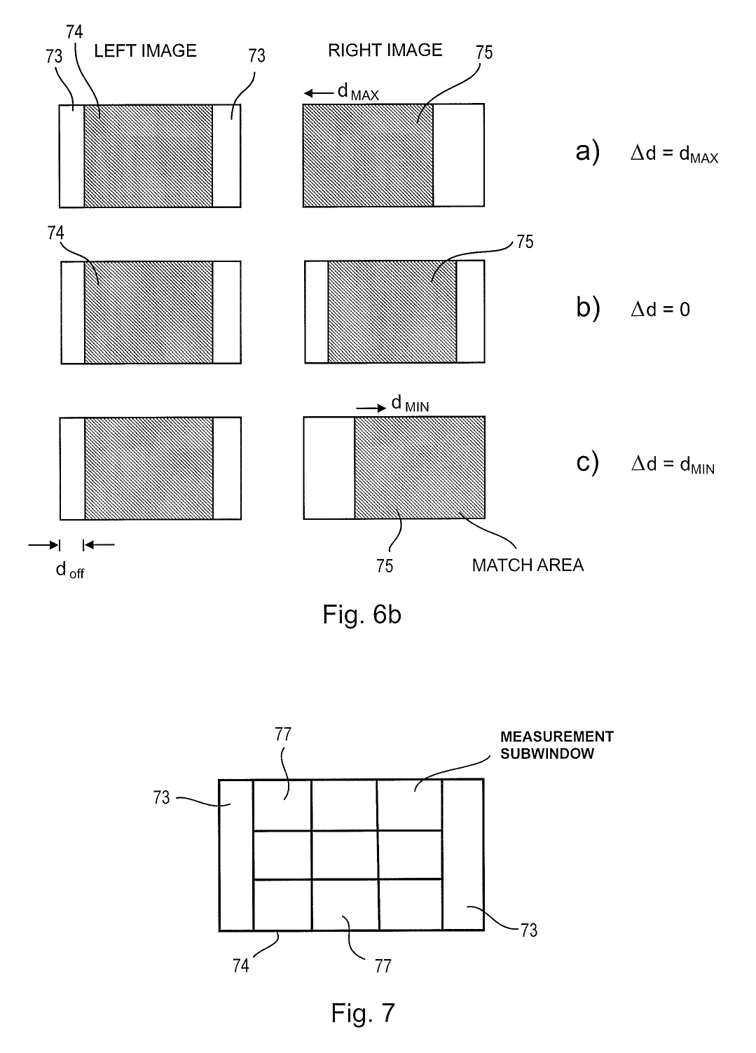

A detailed description of the method carried out by the disparity analysis means 44 is now described with reference to FIG. 6A and 6B.

FIG. 6A is a flow diagram which serves to explain the core principle to determine a disparity distribution for a left and right image pair.

First, some parameter are set to the initial values. In block 60, the disparity shift value is set to Dmin. This value Dmin is generally a negative value and is selected on the basis of the expected minimum disparity in the images. Parallel to the value Dmin, a maximum disparity value Dmax is also provided. This value is determined on the basis of the maximum expected disparity in the images and has usually a positive sign. In a preferred embodiment, Dmin is set to −Dmax, so that the absolute values of Dmin and Dmax are equal and the range defined by both values Dmin, Dmax is symmetrical to zero.

Further, a counter value is set to zero (block 61). The counter value is used in the counter element 56. Further, in block 61, the index values x, y, describing a particular pixel in a two-dimensional pixel array of the image, are set. The y index is set to zero and the x index is set to a value of d_{off}. This value d_{off} determines the width of the cut off margin (indicated as Dmax in FIG. 5). The value d_{off} should be equal or greater than the absolute values of Dmin and Dmax. In a preferred embodiment, d_{off} is set to Dmax.

In the next step (block 62) a correlation step is carried out. This correlation step comprises the subtraction of the pixel value p(x,y) of the left image and the pixel value p(x−Δd, y) of the right image. Since the sign of the difference is not to be considered, the absolute value is calculated and used in the following steps. The absolute value of the difference Δp of the subtraction indicates the extent of the pixel match of the left and the right images. In other words, if the difference Δp is zero, both pixels in the image pair are equal. If the absolute value of the difference Δp is greater than a predetermined threshold THR, which is one in the preferred embodiment, both pixels do not match.

In block 63, the absolute value of the difference Δp is evaluated and if it is below a threshold THR, the counter is increased by 1 (block 64). Otherwise, i.e. both pixels do not match, the counter is not increased.

Next, in block 65, the x index is increased by one and then compared with the value W−d_{off}, wherein W is the width of the image (block 66). If the index x is smaller or equal to W−d_{off} the correlation step is repeated for the next pixel in the same pixel row (i.e. the y index remains unchanged).

After having compared all pixels in a row of the pixel array, the same above-mentioned steps are repeated for the next row of the image's pixel array. Therefore, the x index is again set to d_{off} and the y index is increased by one (block 67). Then, all pixels in the new row are correlated and if a pixel match is determined, the counter is again increased by one.

As it is apparent from FIG. 6A, all pixels of the trimmed left image are correlated with the pixels of an image portion shifted by Δd.

As soon as all pixel rows of the image have been processed (block 68), the value of the counter is stored in the disparity distribution array P(Δd) for the array index Δd (block 69). Then, the disparity shift value is increased by one and the counter is reset to zero. Then, the above described process is repeated for the new disparity shift value Δd.

As soon as the process has been carried out for every value Δd within the range Dmin to Dmax, the process is terminated (block 70) and the disparity distribution array P (Dmin to Dmax) is output for further processing (block 71).

FIG. 6B shows three different shifting value situations in order to illustrate which image areas of the image pair are correlated (or in other words matched or compared).

The first example shows a situation with a disparity shift value of Δd=Dmax. As already mentioned before, only a trimmed image area is taken for the correlation. The left image is hence trimmed by margins 73 so that only a center cut area 74 of the image is employed. The width of the margin 73 is indicated with d_{off}.

The right image which is employed for the correlation is shifted by Dmax, which is in this embodiment a positive value. Hence, the image area, having the same size as the image area of the left image 74, is shifted to the left.

It is apparent from this Figure that the width of the margin d_{off} has to be greater than or equal to the absolute value of Dmax. Otherwise, a part of the shifted image area 75 would lie outside of the valid area.

In the second example, the disparity shift value Δd is zero. Hence, the left image area 74 and the right image area 75 used for the correlation are identical with respect to the position within the whole image. In other words, the image area 75 of the right image is not shifted.

In the third example, the disparity shift value Δd is Dmin, which is a negative value. Here, the image area 75 used for the correlation or match is shifted to the right by Dmin pixels.

It is also to be noted that the width of the margin d_{off} has to be greater than or equal to the absolute values of Dmax and Dmin. Otherwise, a portion of the shifted area 75 of the right image would lie outside of the valid area.

FIG. 6B clearly illustrates again the core principle of the inventive method, namely to correlate an image area of one image with a shifted image area of the other image. The result of the correlation (which is normally a comparison or match) is stored for the used shift value. Then, the correlation is repeated with an image area of the other image further shifted preferably by one pixel. This process is then repeated until the image area of the other image has been shifted from the left boundary (Dmin) to the right boundary (Dmax) of the disparity shifting range.

The result is then a disparity distribution for all disparity values between Dmin and Dmax.

With reference to FIG. 6B it is to be noted that the left image serves as a reference frame and the correlation is “searched” in the right image. However, in other embodiments it could also be that the right image serves as a reference frame and the correlation is searched in the left image. As already mentioned before, it is preferred to set the value Dmin to −Dmax to have a symmetric search range.

The result of the described correlation is the disparity distribution P(d) which is supplied as the disparity distribution Pᵢₙ(d) to the image transformation means 42 (see FIG. 4).

It is apparent from the foregoing detailed description that the correlation is a pixel based operation only using a subtraction of two pixel values. As a consequence, the correlation method for determining the disparity distribution may be implemented very efficiently.

In order to increase the accuracy of the correlation, the above-mentioned correlation can be modified as follows.

In order to avoid masking of peaks corresponding to smaller objects at different depth planes which may happen when the correlation is carried out for the whole image area 74, 75, the image area 74, 75 is divided into a plurality subareas or sub-windows. In FIG. 7, the image area 74 (the image area without the margins 73) is divided into nine equally sized subareas 77. The correlation described above is then applied to every of the nine image subareas 77. Consequently, the correlation provides nine different disparity distributions, one for each image subarea 77.

The advantage of using image subareas is for example that the individual subarea disparity distributions can be differently weighted when combining them to the total disparity distribution supplied to the image transformation means 42.

A further advantage of using image subareas is that so-called object frame violations, i.e. objects located in front of the image plane but cut by the image border, may be detected on the basis of the respective subarea disparity distributions of the top row and/or bottom row subareas.

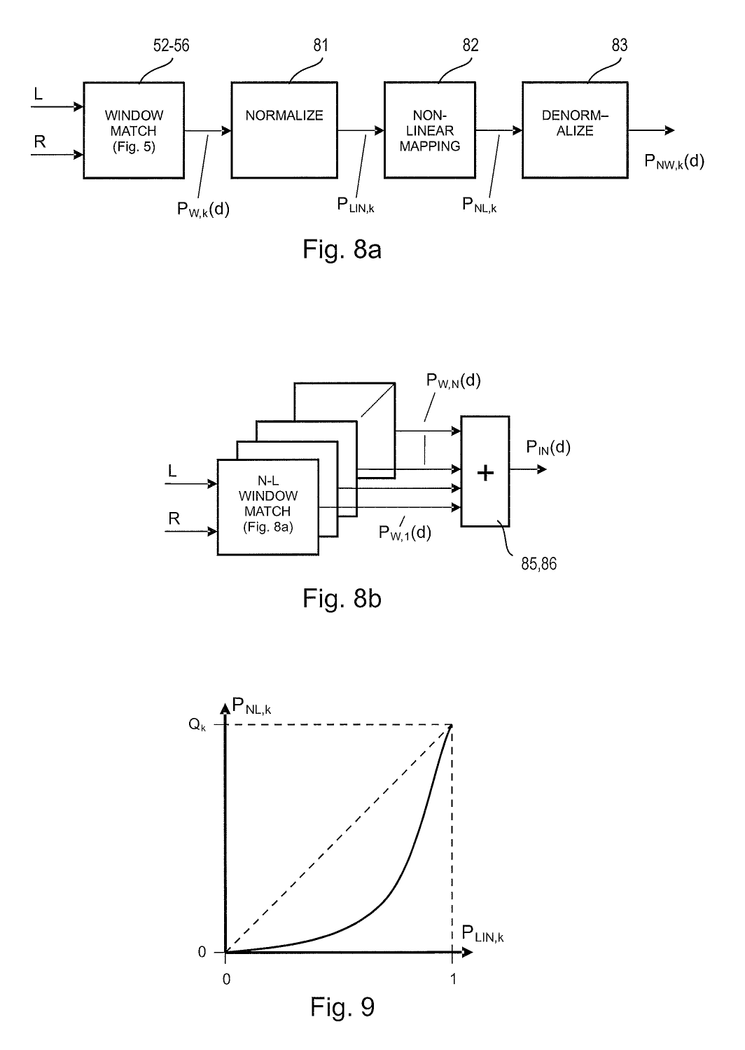

With reference to FIGS. 8 and 9, the post-processing of the disparity distributions of the subareas shown in FIG. 7 are explained.

FIG. 8A shows a block diagram of a portion of the disparity analysis means used for post-processing of the disparity distributions supplied by the portion of the disparity analysis means shown in FIG. 5. The disparity distributions for the image subareas P_{w,k}(d) are supplied to a normalizing element 81. The normalizing element 81 is adapted to normalize each disparity distribution P_{w,k}(d), so that the occurrence or pseudo-probability value P is mapped to the interval zero to one. That is, the disparity distribution for each image subarea contains only values between zero and one.

The normalized disparity distributions for the subareas P_{lin,k} is then supplied to a non-linear mapping element 82. The normalized disparity distribution is transformed by a non-linear monotonic function that effectively attenuates small pseudo-probability values more than large pseudo-probability values.

The output of the non-linear mapping element 82 P_{nl,k} is then supplied to a denormalizing element 83. This element denormalizes the disparity distribution P_{nl,k} by an inversion of the normalization performed by the normalizing element 81. The result is output as the disparity distribution P_{nw,k}(d) for each image subarea.

The post-processed disparity distributions P_{nw,k}(d) for the subareas are then combined by a combining element 85 which is preferably a summing element 86. The result output by the combining element 85 is a single distribution Pᵢₘ(d) that represents the estimated disparity distribution for the stereoscopic input image pair and which is supplied to the image transformation means 42. The combining element 85 with its input of N subarea disparity distributions is shown in FIG. 8B.

As mentioned before, the non-linear mapping element 82 uses a non-linear monotonic function. An example of such a function is shown in FIG. 9. The parameter Qₖ can be used to weight the mapping result. In one embodiment, a value of one is assigned to Qₖ. In another embodiment, the value Qₖ is determined adaptively depending on for example the variants of the normalized distribution or a derivative thereof in order to attenuate or exclude measurements from subareas with only weak image structure. The preferred value range for parameter Qₖ is therefore in the range from value zero to value one. From the diagram shown in FIG. 9, it is apparent that small values P_{lin,k} are considerably attenuated to values near zero whereas larger values near one are not attenuated.

It has been pointed out above that the image area used for correlation is trimmed at the left and right borders. Further, with respect to FIG. 6B it has been shown that the full disparity range cannot be used due to potentially extending the search to areas outside the image border. In particular, in the example shown in FIG. 6B the left image area has been used as a reference area for all disparity shift values between Dmin and Dmax.However, it is also possible to switch the role of the reference area 74 and the match area 75 in the left and the right images depending on the border (left or right) and the sign of the search disparity d.

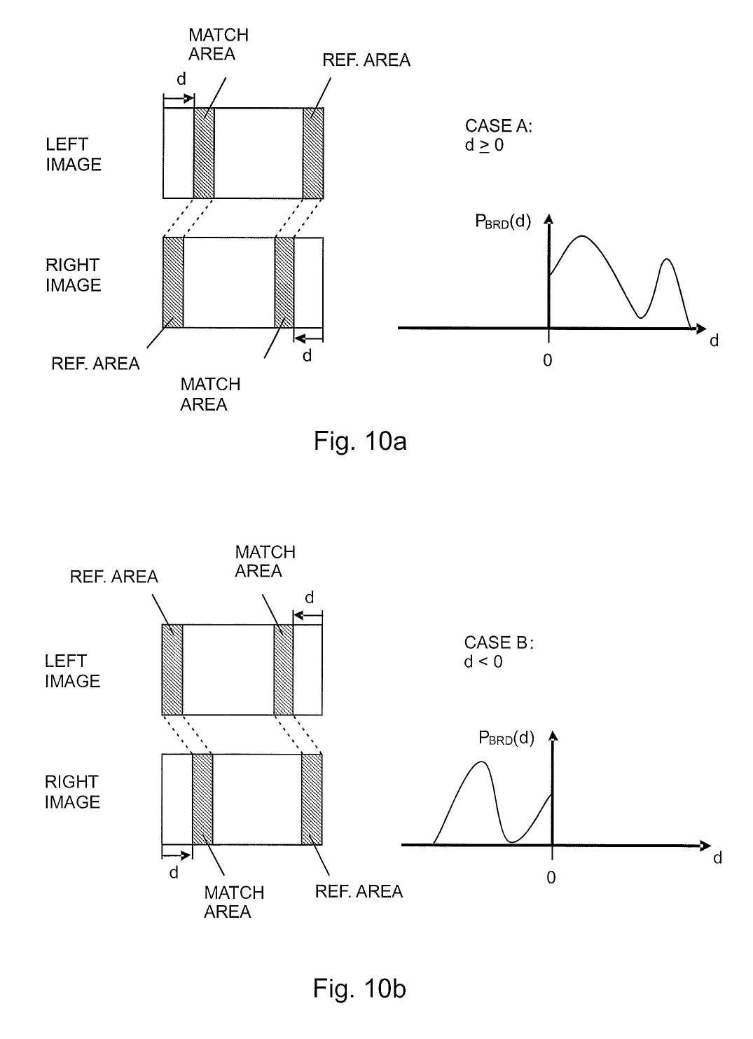

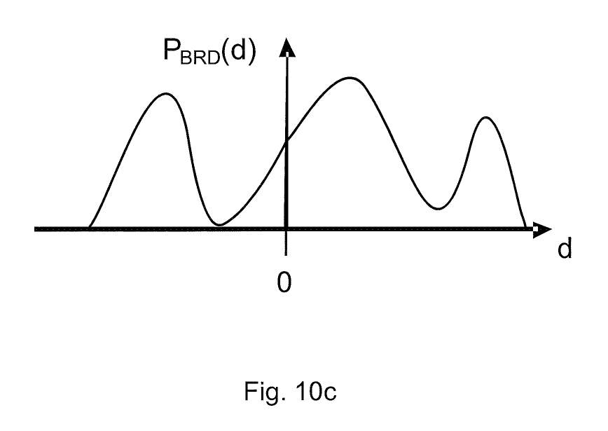

In FIG. 10A, the reference and match areas are shown for the positive lobe of the disparity shift range.

In FIG. 10B, the reference and match areas are shown for the negative lobe of the disparity search range, and FIG. 10C displays the resulting complete border disparity distribution assembled from the positive and negative lobes according to FIGS. 10A and 10B.

In particular FIGS. 10a-10c depict the computation of the disparity distribution at the left and right picture borders for the full range from Dmin to Dmax and in case the Dmin is lower than zero and Dmax is larger than zero. Also shown is the effective measurement area used to estimate the disparity distributions at the left and the right image border. Since the approach shown in FIG. 6 cannot be used for the full disparity range, due to potentially extending the search to areas outside the image border, the role of the reference and the search area in left and right image are switched depending on the border (left or right) and the sign of the search disparity d. FIG. 10a shows reference and match areas for the positive lobe of the disparity search range. FIG. 10b shows reference and match areas for the negative lobe of the disparity search range, and FIG. 10c shows the resulting complete border disparity distribution assembled from the positive and negative lobes.

The described method for estimating the disparity distribution of an image pair is suitable for stereoscopic material that contains rectified left and right views, i.e. that epipolar lines of the inherent view geometry are aligned with the image rows. Furthermore, left and right view should have equal exposure or brightness. While these requirements ensure best portrayal on a stereoscopic display, they are still violated by most of today's content.

The proposed and above described method can therefore be extended to include also preprocessing means to first compensate global illumination differences between left and right views. Secondly, a vertical shift between left and right correlation image areas is determined for each correlation area. Finally, the horizontal distribution is estimated as described above.

To summarize the main advantages of the invention, it is computationally more efficient than the mentioned naïve approach. Further, it is less complex than the naïve approach. Therefore, it can be implemented more easily in hardware (e.g. ASIC) or in software for processors with vectorized computational units (e.g. VLIW, CELL). And the inventive method is more robust than the naïve approach for content that exposes periodic structures.

The invention has been illustrated and described in detail in the drawings and foregoing description, but such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1-42. (canceled)

43. A method for estimating a disparity distribution between a left image and a right image of a stereoscopic 3D picture, each image having an array of pixels, comprising:
providing a maximum range of disparity;
correlating a left image area with a right image area, with one of the left and right image areas being shifted by a disparity shift value, wherein a result of the correlation is an indication of a pixel match between the left and right images;
repeating the correlating for a set of disparity shift values within the maximum range of disparity; and
deriving the disparity distribution from results of the correlation.

44. A method as claimed in claim 43, wherein the set of disparity shift values comprises all integer values within the maximum range of disparity, wherein a unit of the disparity shift value as well as the maximum range of disparity is a pixel.

45. A method as claimed in claim 43, wherein the image area used for correlating is an overlapping area of one image area and a shifted other image area.

46. A method as claimed in claim 43, wherein the left and the right image areas for correlating are trimmed at their left and right borders by a value, or a value corresponding to the maximum range of disparity.

47. A method as claimed in claim 43, wherein the correlating comprises:
comparing the left and right image areas with each other pixelwise; and
increasing a counter in response to a result of the comparison, wherein the counter indicates a match of pixel values for the left and right image areas, one of which being shifted by the disparity shift value.

48. A method as claimed in claim 47, wherein the comparing the left and right image areas pixelwise comprises subtracting the value of each pixel of one of the left and right image areas from the value of each respective pixel of the other of the left and right image areas.

49. A method as claimed in claim 48, wherein the counter is increased if the absolute value of the result of the comparison is below a predetermined threshold.

50. A method as claimed in claim 49, wherein the threshold is one.

51. A method as claimed in claim 43, wherein the left and right image areas are shifted horizontally relative to each other.

52. A method as claimed in claim 43, wherein the left and right image areas are divided into a number of subareas, and the correlating is carried out for each subarea separately, so that a disparity distribution is derived for every image subarea.

53. A method as claimed in claim 52, wherein the disparity distribution of the subareas are combined to a single distribution.

54. A method as claimed in claim 53, wherein the number of subareas is nine.

55. A method as claimed in claim 52, further comprising:
analyzing each subarea whether it contains any structured elements.

56. A method as claimed in claim 55, further comprising:
determining a weight factor for each subarea depending on the analyzing result, wherein the weight factor is used for a combination of the disparity distributions.

57. A method as claimed in claim 52, further comprising:
applying a non-linear transfer function to each subarea disparity distribution before combining the subarea disparity distributions to enhance large peaks and attenuate small peaks and noise.

58. A method as claimed in claim 53, wherein the combining the disparity distributions comprises adding-up the subarea disparity distribution.

59. A method as claimed in claim 52, wherein a set of subarea disparity distributions is combined.

60. A method as claimed in claim 59, wherein the set of subarea disparity distributions only comprises those relating to subareas located at an image border.

61. A method as claimed in claim 60, wherein the set of subarea disparity distributions is used to search for border violations.

62. A method as claimed in claim 43, further comprising:
compensating for global illumination differences between the left and right images; and/or
determining a vertical shift between the left and right image areas, wherein both the compensating and the determining are carried out before the correlating.

63. An apparatus for estimating a disparity distribution between a left image and a right image of a stereoscopic 3D picture, each image having an array of pixels, comprising:
an estimation device configured to:
correlate a left image area with a right image area, with one of the left and right image areas being shifted by a disparity shift value, wherein a result of the correlation is an indication of a pixel match between the left and right images;
repeat the correlate for a set of disparity shift values within a given maximum range of disparity;
derive a disparity distribution from the results of the correlation; and
output the derived disparity distribution.

64. An apparatus as claimed in claim 63, wherein the set of disparity shift values comprises all integer values within the maximum range of disparity, wherein a unit of the disparity shift value as well as the maximum range of disparity is a pixel.

65. An apparatus as claimed in claim 63, wherein the image area used for correlating is an overlapping area of one image area and a shifted other image area.

66. An apparatus as claimed in claim 63, wherein the estimation device is configured to trim the left and the right image areas for correlating at their left and right borders by a value corresponding to the maximum range.

67. An apparatus as claimed in claim 63, wherein the estimation device is further configured to:
compare the left and right image areas with each other pixelwise; and
increasing a counter in response to a result of the comparison, wherein the counter indicates a match of pixel values for the left and right image areas, one of which being shifted by the disparity shift value.

68. An apparatus as claimed in claim 67, wherein the estimation device is further configured to subtract the value of each pixel of one of the left and right image areas from the value of each respective pixel of the other of the left and right image areas.

69. An apparatus as claimed in claim 68, wherein the estimation device is configured to increase a counter if the absolute value of the result of the comparison is below a predetermined threshold.

70. An apparatus as claimed in claim 63, wherein the threshold is one.

71. An apparatus as claimed in claim 63, wherein the left and right image areas are shifted horizontally relative to each other.

72. An apparatus as claimed in claim 63, wherein the estimation device is configured to divide the left and right image areas into a number of subareas, and to correlate each subarea separately, so that a disparity distribution is derived for every image subarea.

73. An apparatus as claimed in claim 72, wherein the estimation device is configured to combine the disparity distribution of the subareas to a single distribution.

74. An apparatus as claimed in claim 72, wherein the number of subareas is nine.

75. An apparatus as claimed in claim 72, wherein the estimation device is configured to analyze each subarea whether it contains any structured elements.

76. An apparatus as claimed in claim 75, wherein the estimation device is configured to determining a weight factor for each subarea depending on the analyzing result, wherein the weight factor is used for a combination of the disparity distributions.

77. An apparatus as claimed in claim 72, wherein the estimation device is configured to apply a non-linear transfer function to each subarea disparity distribution before combining the subarea disparity distributions to enhance large peaks and attenuate small peaks and noise.

78. An apparatus as claimed in claim 73, wherein the estimation device is configured to add-up the subarea disparity distribution for combining the disparity distributions.

79. An apparatus as claimed in claim 72, wherein the estimation device is configured to combine a set of subarea disparity distributions.

80. An apparatus as claimed in claim 79, wherein the set of subarea disparity distributions only comprises those relating to subareas located at the image border.

81. An apparatus as claimed in claim 63, wherein the estimation device is provided as an ASIC.

82. An apparatus for recording, processing and/or displaying stereoscopic 3D pictures, comprising an apparatus as claimed in claim 63.

83. An apparatus as claimed in claim 82, wherein the apparatus is one of a television set, a still picture camera device, a video camera device, a media player device, a gaming console, a content post-production system.

84. A non-transitory computer readable medium including computer executable instructions which, when executed on a digital system, enable the digital system to carry out the method of claim 43.
